(19) United States
(12) Patent Application Publication
(10) Pub. No.: US 2026/0304131 A1
(43) Pub. Date: Oct. 1, 2026

(54) CONTEXT-BASED SECURITY BY INSPECTING INTERFACES BETWEEN RAN AND CORE IN MOBILE NETWORKS

(71) Applicant: Palo Alto Networks, Inc., Santa Clara, CA (US)

(72) Inventors: Sachin Verma, Pleasanton, CA (US); Leonid Burakovsky, Pleasanton, CA (US)

(21) Appl. No.: 19/096,440

(22) Filed: Mar. 31, 2025

(51) Int. Cl. H04W 12/37; H04W 12/122

(52) U.S. Cl. CPC H04W 12/37; H04W 12/122

(57) ABSTRACT

Techniques for providing context-based security by inspecting interfaces in mobile networks are disclosed. In some embodiments, a system/process/computer program product for providing context-based security by inspecting interfaces in mobile networks includes monitoring network traffic at an interface between a radio access network (RAN) and a core of a mobile network at a security platform to identify an attach request message or an initial context setup message associated with a new session; extracting a plurality of parameters from the attach request message or the initial context setup message to associate contextual information with the new session at the security platform; and enforcing a security policy at the security platform on the new session based on one or more of the plurality of parameters to apply context-based security to the network traffic in the mobile network.

### BACKGROUND OF THE INVENTION

A firewall generally protects networks from unauthorized access while permitting authorized communications to pass through the firewall. A firewall is typically a device or a set of devices, or software executed on a device, such as a computer, which provides a firewall function for network access. For example, firewalls can be integrated into operating systems of devices (e.g., computers, smart phones, or other types of network communication capable devices). Firewalls can also be integrated into or executed as software on computer servers, gateways, network/routing devices (e.g., network routers), or data appliances (e.g., security appliances or other types of special purpose devices).

Firewalls typically deny or permit network transmission based on a set of rules. These sets of rules are often referred to as policies. For example, a firewall can filter inbound traffic by applying a set of rules or policies. A firewall can also filter outbound traffic by applying a set of rules or policies. Firewalls can also be capable of performing basic routing functions.

### BRIEF DESCRIPTION OF THE DRAWINGS

Various embodiments of the invention are disclosed in the following detailed description and the accompanying drawings.

FIG. 1A is an example deployment architecture diagram for providing context-based security by inspecting interfaces in a 4G network in accordance with some embodiments.

FIG. 1B is an example deployment architecture diagram for providing context-based security by inspecting interfaces in a 5G network in accordance with some embodiments.

FIG. 1C is an example deployment architecture diagram for providing context-based security by inspecting interfaces in an Open RAN 5G network in accordance with some embodiments.

FIG. 1D is an example deployment architecture diagram for providing context-based security by inspecting interfaces in a 4G access, 5G access, and 4G-5G mobility network environment in accordance with some embodiments.

FIG. 2A is a sequence diagram for an E-UTRAN initial attach in a 4G/LTE network environment in accordance with some embodiments.

FIG. 2B is a sequence diagram for a UE-initiated detach procedure for E-UTRAN in a 4G/LTE network environment in accordance with some embodiments.

FIG. 2C is a sequence diagram for an MME-initiated detach procedure for E-UTRAN in a 4G/LTE network environment in accordance with some embodiments.

FIG. 2D is a sequence diagram for an initial context setup procedure in a 5G network environment in accordance with some embodiments.

FIG. 2E is a sequence diagram for a UE-initiated detach procedure in a 5G network environment in accordance with some embodiments.

FIG. 2F is a sequence diagram for a UE context release procedure (NG-RAN node initiated) in a 5G network environment in accordance with some embodiments.

FIG. 2G is a sequence diagram for a UE context release procedure (AMF initiated) in a 5G network environment in accordance with some embodiments.

FIG. 3 is a flow diagram of a process for providing context-based security by inspecting interfaces in mobile networks in accordance with some embodiments.

FIG. 4 is another flow diagram of a process for providing context-based security by inspecting interfaces in mobile networks in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A firewall generally protects networks from unauthorized access while permitting authorized communications to pass through the firewall. A firewall is typically a device, a set of devices, or software executed on a device that provides a firewall function for network access. For example, a firewall can be integrated into operating systems of devices (e.g., computers, smart phones, or other types of network communication capable devices). A firewall can also be integrated into or executed as software applications on various types of devices or security devices, such as computer servers, gateways, network/routing devices (e.g., network routers), or data appliances (e.g., security appliances or other types of special purpose devices).

Firewalls typically deny or permit network transmission based on a set of rules. These sets of rules are often referred to as policies (e.g., network policies or network security policies). For example, a firewall can filter inbound traffic by applying a set of rules or policies to prevent unwanted outside traffic from reaching protected devices. A firewall can also filter outbound traffic by applying a set of rules or policies (e.g., allow, block, monitor, notify or log, and/or other actions can be specified in firewall/security rules or firewall/security policies, which can be triggered based on various criteria, such as described herein). A firewall may also apply anti-virus protection, malware detection/prevention, or intrusion protection by applying a set of rules or policies.

Security devices (e.g., security appliances, security gateways, security services, and/or other security devices) can include various security functions (e.g., firewall, anti-malware, intrusion prevention/detection, proxy, and/or other security functions), networking functions (e.g., routing, Quality of Service (QoS), workload balancing of network related resources, and/or other networking functions), and/or other functions. For example, routing functions can be based on source information (e.g., source IP address and port), destination information (e.g., destination IP address and port), and protocol information.

A basic packet filtering firewall filters network communication traffic by inspecting individual packets transmitted over a network (e.g., packet filtering firewalls or first generation firewalls, which are stateless packet filtering firewalls). Stateless packet filtering firewalls typically inspect the individual packets themselves and apply rules based on the inspected packets (e.g., using a combination of a packet's source and destination address information, protocol information, and a port number).

Application firewalls can also perform application layer filtering (e.g., using application layer filtering firewalls or second generation firewalls, which work on the application level of the TCP/IP stack). Application layer filtering firewalls or application firewalls can generally identify certain applications and protocols (e.g., web browsing using HyperText Transfer Protocol (HTTP), a Domain Name System (DNS) request, a file transfer using File Transfer Protocol (FTP), and various other types of applications and other protocols, such as Telnet, DHCP, TCP, UDP, and TFTP (GSS)). For example, application firewalls can block unauthorized protocols that attempt to communicate over a standard port (e.g., an unauthorized/out of policy protocol attempting to sneak through by using a non-standard port for that protocol can generally be identified using application firewalls).

Stateful firewalls can also perform stateful-based packet inspection in which each packet is examined within the context of a series of packets associated with that network transmission's flow of packets/packet flow (e.g., stateful firewalls or third generation firewalls). This firewall technique is generally referred to as a stateful packet inspection as it maintains records of all connections passing through the firewall and is able to determine whether a packet is the start of a new connection, a part of an existing connection, or is an invalid packet. For example, the state of a connection can itself be one of the criteria that triggers a rule within a policy.

Advanced or next generation firewalls can perform stateless and stateful packet filtering and application layer filtering as discussed above. Next generation firewalls can also perform additional firewall techniques. For example, certain newer firewalls sometimes referred to as advanced or next generation firewalls can also identify users and content. In particular, certain next generation firewalls are expanding the list of applications that these firewalls can automatically identify to thousands of applications. Examples of such next generation firewalls are commercially available from Palo Alto Networks, Inc. (e.g., Palo Alto Networks' PA Series next generation firewalls, Palo Alto Networks' VM Series virtualized next generation firewalls, and CN Series container next generation firewalls).

For example, Palo Alto Networks' next generation firewalls enable enterprises and service providers to identify and control applications, users, and content—not just ports, IP addresses, and packets—using various identification technologies, such as the following: App-ID™ (e.g., App ID) for accurate application identification, User-ID™ (e.g., User ID) for user identification (e.g., by user or user group), and Content-ID™ (e.g., Content ID) for real-time content scanning (e.g., controls web surfing and limits data and file transfers). These identification technologies allow enterprises to securely enable application usage using business-relevant concepts, instead of following the traditional approach offered by traditional port-blocking firewalls. Also, special purpose hardware for next generation firewalls implemented, for example, as dedicated appliances generally provides higher performance levels for application inspection than software executed on general purpose hardware (e.g., such as security appliances provided by Palo Alto Networks, Inc., which utilize dedicated, function specific processing that is tightly integrated with a single-pass software engine to maximize network throughput while minimizing latency for Palo Alto Networks' PA Series next generation firewalls).

### Overview of Techniques for Providing Context-Based Security by Inspecting Interfaces Between RAN and Core in Mobile Networks

Generally, enterprise customers are sometimes not able to apply context-based security in their private mobile networks (e.g., enterprise private mobile networks). Specifically, many enterprise customers are not able to apply context-based security (e.g., based on a Subscriber ID and/or an Equipment ID, or other contextual information associated with mobile network traffic) in their private mobile networks (e.g., private 4G/5G/6G or later generation mobile networks).

More specifically, a security platform (e.g., NGFW and/or other security platform/device/entity/function) is not able to monitor (e.g., and inspect) Radius protocol and Packet Forwarding Control Protocol (PFCP) traffic in a typical private mobile network. Monitoring/access to such Radius and PFCP traffic is generally required to extract mobile identities, such as Subscriber ID and/or Equipment ID (e.g., International Mobile Subscription Identity (IMSI)/Subscription Permanent Identifier (SUPI), International Mobile Equipment Identity (IMEI)/Permanent Equipment Identifier (PEI), Mobile Station International Subscriber Directory Number (MSISDN)) due to the typically closed nature of private mobile core networks and/or the Radius function is not supported by some private mobile core network related equipment vendors.

As such, technical challenges exist for providing context-based security by inspecting interfaces in mobile networks.

Accordingly, new and improved techniques for providing context-based security by inspecting interfaces in mobile networks are disclosed.

In some embodiments, a system, a process, and/or a computer program product for providing context-based security by inspecting interfaces in mobile networks includes monitoring network traffic at an interface in a core mobile network (e.g., a 4G/Long Term Evolution (LTE) core network, a 5G core network, an Open Radio Access Network (RAN) core network, and/or a 4G/Long Term Evolution (LTE) core network and a 5G core network) at a security platform (e.g., an NGFW or another security entity/device/function) to identify an attach request message or an initial context setup message associated with a new session; extracting a plurality of parameters from the attach request message or the initial context setup message to associate contextual information with the new session at the security platform; and enforcing a security policy at the security platform on the new session based on one or more of the plurality of parameters to apply context-based security to the network traffic in the core mobile network.

In some embodiments, a system, a process, and/or a computer program product for providing context-based security by inspecting interfaces in mobile networks further includes monitoring network traffic at an S1-MME interface and an S1-U interface in a 4G/Long Term Evolution (LTE) core network at the security platform to identify the attach request message associated with the new session.

In some embodiments, a system, a process, and/or a computer program product for providing context-based security by inspecting interfaces in mobile networks further includes monitoring network traffic at an S1-MME interface and/or an S1-U interface in a 4G/Long Term Evolution (LTE) core network at the security platform to identify the attach request message associated with the new session to extract the contextual information; and storing the contextual information locally in the security platform or in a cloud-based storage.

In some embodiments, a system, a process, and/or a computer program product for providing context-based security by inspecting interfaces in mobile networks further includes monitoring network traffic at an N2 interface and/or an N3 interface in a 5G core network and/or an Open Radio Access Network (Open RAN) core network at the security platform to identify the initial context setup associated with the new session.

In some embodiments, a system, a process, and/or a computer program product for providing context-based security by inspecting interfaces in mobile networks further includes monitoring network traffic at an N2 interface and/or an N3 interface in a 5G core network and/or an Open Radio Access Network (Open RAN) core network at the security platform to identify the initial context setup associated with the new session; and storing the contextual information locally in the security platform or in a cloud-based storage.

In an example implementation for a 4G/LTE network environment, the extracted plurality of parameters includes one or more of the following: Transport Layer Internet Protocol (IP) address, General Packet Radio Service (GPRS) Tunneling Protocol (GTP) Tunnel Endpoint Identifier (GTP-TEID), User Equipment (UE) IP address, International Mobile Equipment Identifier (IMEI), Mobile Temporary Mobile Subscriber Identity (M-TMSI), Access Point Name (APN)/Data Network Name (DNN), and Location information.

In an example implementation for a 5G and/or Open Radio Access Network (O-RAN) network environment, the extracted plurality of parameters includes one or more of the following: UE (IP) address, Transport Layer IP address, General Packet Radio Service (GPRS) Tunneling Protocol (GTP) Tunnel Endpoint Identifier (GTP-TEID), PDU Session ID, and International Mobile Equipment Identifier (IMEI)/Permanent Equipment Identifier (PEI).

In an example implementation for a private 4G/LTE network environment, a private 5G network environment, and/or a private O-RAN network environment, the extracted plurality of parameters includes masked International Mobile Equipment Identity—Software Version (IMEISV).

In some embodiments, a system, a process, and/or a computer program product for providing context-based security by inspecting interfaces in mobile networks further includes blocking the new session from accessing a resource based on the security policy.

In some embodiments, a system, a process, and/or a computer program product for providing context-based security by inspecting interfaces in mobile networks further includes allowing the new session to access a resource based on the security policy.

For example, using the disclosed techniques, the security platform can be configured to perform detection and prevention of known and unknown threat identification and prevention in a private mobile core network and/or a service provider network.

As another example, using the disclosed techniques the security platform can be configured to perform application identification and control in a private mobile core network and/or a service provider network.

As yet another example, using the disclosed techniques the security platform can be configured to perform Uniform Resource Link (URL) filtering in a private mobile core network and/or a service provider network.

Various system embodiments for providing context-based security by inspecting interfaces in mobile networks will now be further described below.

### Example System Embodiments for Providing Context-Based Security by Inspecting Interfaces Between RAN and Core in Mobile Networks

Accordingly, in some embodiments, the disclosed techniques for providing context-based security by inspecting interfaces in mobile networks (e.g., private/enterprise mobile networks) include providing a security platform (e.g., the security function(s)/platform(s) can be implemented using a firewall (FW)/Next Generation Firewall (NGFW), a network sensor acting on behalf of the firewall, or another (virtual) device/component that can implement security policies using the disclosed techniques, such as PANOS executing on a virtual/physical NGFW solution commercially available from Palo Alto Networks, Inc. or another security platform/NGFW, including, for example, Palo Alto Networks' PA Series next generation firewalls, Palo Alto Networks' VM Series virtualized next generation firewalls, and CN Series container next generation firewalls, and/or other commercially available virtual-based or container-based firewalls can similarly be implemented and configured to perform the disclosed techniques) configured to provide DPI capabilities (e.g., including stateful inspection) of, for example, GTP-C sessions (e.g., GTP-C traffic) and/or GTP-U sessions (e.g., GTP-U traffic) over S1-MME and S1-U interfaces between an eNodeB and Mobility Management Entity (MME) (e.g., an MME generally provides a control plane function that handles an initial attach of the User Equipment (UE) to a 4G core network and it also authenticates the user and authorizes their access to a 4G network) in a 4G network and/or over N2 and N3 interfaces between an NG-RAN node and Access and Mobility Management Function (AMF) (e.g., an AMF generally provides a control plane function that manages user equipment (UE) registration, authentication, authorization, and mobility within a 5G core network (5GC)) in a 5G network to apply context-based security on user plane traffic based on a policy (e.g., layer-7 security and/or other context-based security policy enforcement) as further described below. As another example, the security platform can be configured to correlate the context information with the user plane traffic to deliver the context-based security capabilities for inter node traffic of 4G and/or 5G networks.

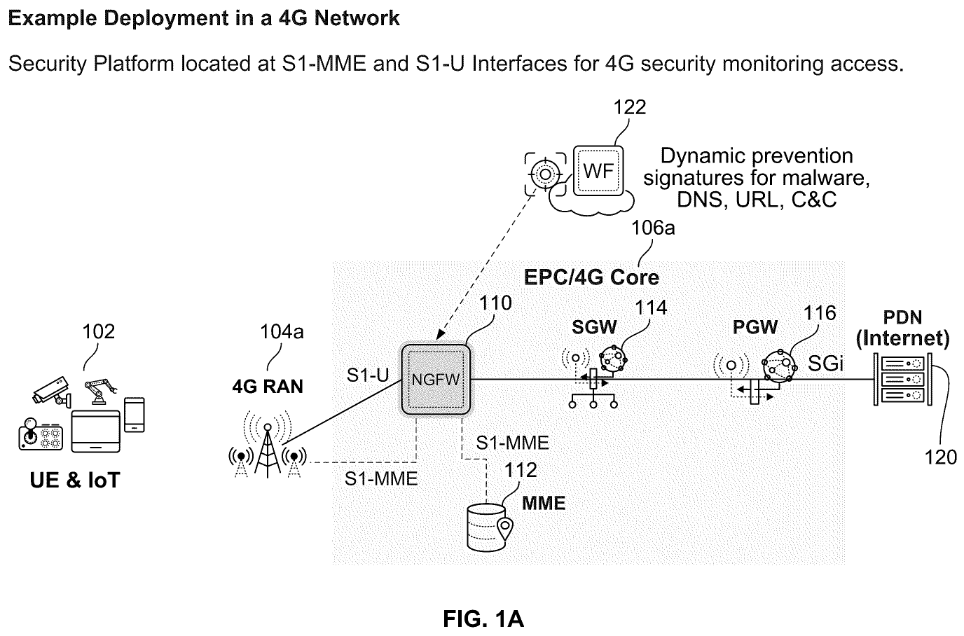

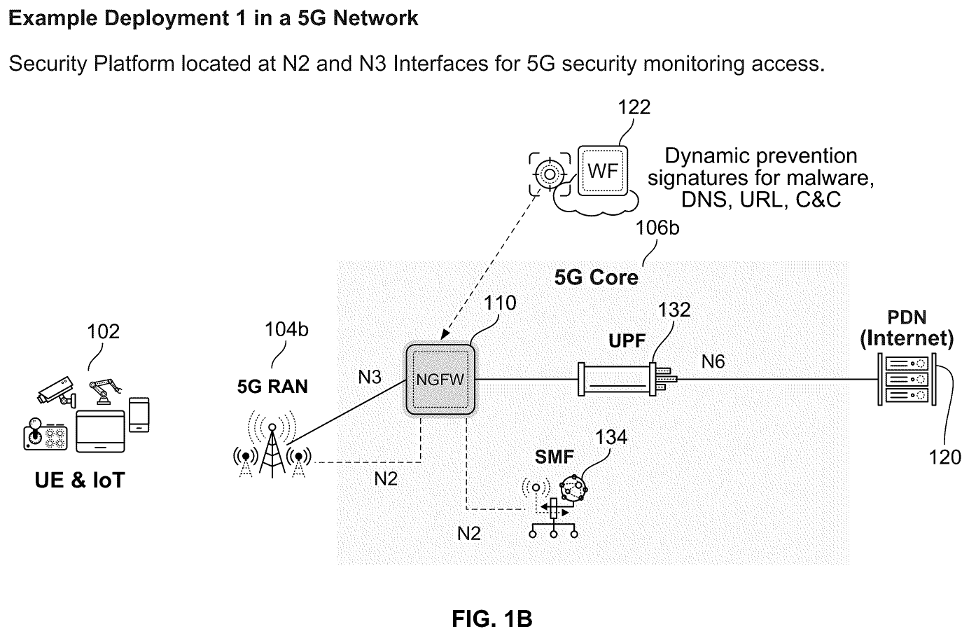

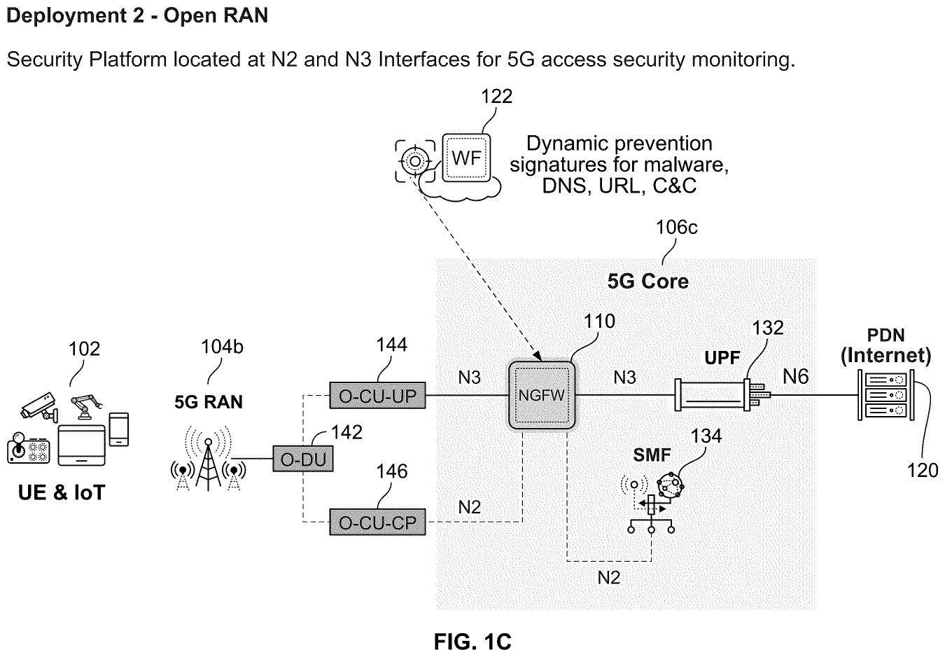

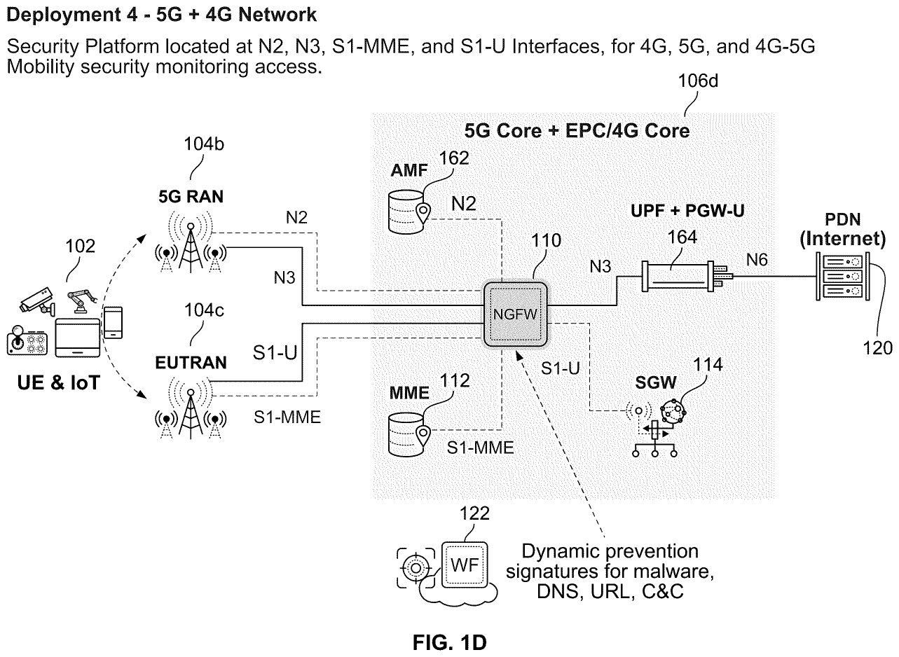

FIG. 1A is an example deployment architecture diagram for providing context-based security by inspecting interfaces in a 4G network in accordance with some embodiments. In this example deployment, a security platform (e.g., NGFW) as shown at 110 is deployed in a location within 4G core mobile network 106a to monitor S1-MME and S1-U interfaces to facilitate providing context-based security by inspecting interfaces between RAN and Core in a 4G network (e.g., a private/enterprise 4G network) as further described below.

Specifically, FIG. 1A is an example 4G mobile network environment that includes a Security Platform 110 (e.g., the security function(s)/platform(s) can be implemented using a firewall (FW)/Next Generation Firewall (NGFW), a network sensor acting on behalf of the firewall, or another (virtual) device/component that can implement security policies using the disclosed techniques, including, for example, Palo Alto Networks' PA Series next generation firewalls, Palo Alto Networks' VM Series virtualized next generation firewalls, and CN Series container next generation firewalls, and/or other commercially available virtual-based or container-based firewalls can similarly be implemented and configured to perform the disclosed techniques) for applying context-based security by inspecting interfaces between RAN and Core in mobile networks (e.g., 4G, 5G, 6G, or later generation mobile networks) as further described below.

As shown, the 4G mobile network environment can also include 4G Radio Access Network (RAN) access (e.g., gNodeB (gNB)) as shown at 104A, and/or other networks (not shown in FIG. 1A) to facilitate data communications for subscribers (e.g., using User Equipment (UE), such as smart phones, laptops, computers (which may be in a fixed location), and/or other cellular enabled computing devices/equipment, such as UE and Internet of Things (IoT) devices as shown at 102, or other network communication enabled devices such as Industrial IoT (IIoT), etc.) including over a Packet Data Network (PDN) (e.g., the Internet) 120 to access various applications (e.g., including Software Applications as a Services (SaaS)), web services, content hosts, etc. and/or other networks. As shown in FIG. 1A, the 4G network access mechanisms 104A are in communication over various interfaces, including the S1-U interface and S1-MME interface with EPC/4G Core network 106a.

In this example implementation, security platform (e.g., NGFW) 110 is located in EPC/4G Core network 106a between 4G RAN 104a and Mobility Management Entity (MME) 112 via the S1-MME interface as shown and also between 4G RAN 104a and Serving Gateway (SGW) 114 via the S1-U interface, as also shown in FIG. 1A. SGW 114 is also in communication with Packet Data Network Gateway (PGW) 116, which is in communication with PDN (e.g., Internet) 120 via the SGi interface.

Referring to FIG. 1A, network traffic communications are monitored using Security Platform 110. As shown, network traffic communications are monitored/filtered in the 4G network using Security Platform 110 (e.g., (virtual) devices/appliances that each include a firewall (FW), a network sensor acting on behalf of the firewall, or another device/component that can implement security policies using the disclosed techniques), configured to perform the disclosed techniques for applying context-based security by inspecting interfaces, such as in this example a 4G network environment, S1-MME and S1-U interfaces, such as similarly described above and as further described below.

In some embodiments, the security platform is configured to provide the following DPI capabilities: inspection of S1 Application Protocol (AP) (S1AP) traffic over S1-MME and GPRS Tunneling Protocol User Plane (GTP-U) over S1-U interfaces and to apply context-based security as described herein.

As such, in this example implementation for a private 4G mobile network deployment, a security platform (e.g., NGFW and/or other security platform/device/entity/function) is deployed in a private 4G network. Specifically, the security platform is configured to monitor predetermined interfaces in the private 4G network, including in this example implementation, S1-MME and S1-U interfaces.

Specifically, the security platform processes S1AP messages (e.g., over the S1 Application Protocol (AP) in which such S1AP messages are used for communications between the 4G RAN (e.g., eNodeB (eNB)) and the Mobility Management Entity (MME) in 4G networks) over S1-MME and S1-U interfaces. Example monitored S1AP messages include the “Attach Request” message that is exchanged between an eNB (104a) and an MME (112) during an “Attach procedure” (e.g., as specified in 3GPP Technical Specification (TS) 23.401 version 18.8.0, which is publicly available at https://www.etsi.org/deliver/etsi_ts/123400_123499/123401/18.08.00_60/ts_123401v180800p.pdf) to extract the following example parameters/information: Transport Layer Internet Protocol (IP) address, General Packet Radio Service (GPRS) Tunneling Protocol (GTP) Tunnel Endpoint Identifier (GTP-TEID), International Mobile Equipment Identifier (IMEI), Mobile Temporary Mobile Subscriber Identity (M-TMSI), Access Point Name (APN)/Data Network Name (DNN), and Location information.

In addition, the S1AP “Attach request” message includes masked International Mobile Equipment Identity-Software Version (IMEISV) by default. The MMEs of certain 4G mobile core equipment vendors have a configuration option to enable and disable the masking of the IMEISV. In public networks, masking the IMEI is generally a default for security purposes. However, in private 4G networks, the IMEISV masking can be disabled to facilitate collecting of equipment identity for adding advanced network level security for UEs. As such, in private 4G network deployments in which the IMEISV masking is disabled, the security platform can also extract the IMEI information.

Technical details for monitoring predetermined interfaces including, for example, S1-MME and S1-U interfaces in private 4G networks using a security platform will be further described below with respect to various embodiments.

Moreover, the security platform can correlate the context information with the user plane traffic to deliver enhanced context-based security capabilities for network traffic in 4G networks.

In addition, Security Platform 110 can also be in network communication with a Cloud Security Service 122 (e.g., a commercially available cloud-based security service, such as the WildFire™ cloud-based malware analysis environment that is a commercially available cloud security service provided by Palo Alto Networks, Inc., which includes automated security analysis of malware samples as well as security expert analysis, or a similar solution provided by another vendor can be utilized), such as via the Internet. For example, Cloud Security Service 122 can be utilized to provide the Security Platforms with dynamic prevention signatures for malware, DNS, URLs, CNC malware, and/or other malware as well as to receive malware samples for further security analysis.

As will now be apparent to one of ordinary skill in the art in view of the disclosed embodiments, various other security platform deployments in private 4G networks can similarly be used to facilitate providing context-based security by inspecting interfaces in a 4G network as described herein. For example, as will now be apparent, network traffic communications can be monitored/filtered at the interfaces (e.g., S1-U, S1-MME, SGi, etc.) in private 4G networks using one or more security platforms for network traffic communications in various locations within the private 4G network (e.g., private enterprise 4G network) to facilitate applying context-based security by inspecting interfaces in mobile networks.

FIG. 1B is an example deployment architecture diagram for providing context-based security by inspecting interfaces in a 5G network in accordance with some embodiments. In this example deployment, a security platform (e.g., NGFW) as shown at 110 is deployed in a location within 5G core mobile network 106b to monitor N2 and N3 interfaces to facilitate providing context-based security by inspecting interfaces in a 5G network (e.g., a private/enterprise 5G network) as further described below.

Specifically, FIG. 1B is an example 5G mobile network environment that includes a Security Platform 110 (e.g., the security function(s)/platform(s) can be implemented using a firewall (FW)/Next Generation Firewall (NGFW), a network sensor acting on behalf of the firewall, or another (virtual) device/component that can implement security policies using the disclosed techniques, including, for example, Palo Alto Networks' PA Series next generation firewalls, Palo Alto Networks' VM Series virtualized next generation firewalls, and CN Series container next generation firewalls, and/or other commercially available virtual-based or container-based firewalls can similarly be implemented and configured to perform the disclosed techniques) for applying context-based security by inspecting interfaces in mobile networks (e.g., 4G, 5G, 6G, or later generation mobile networks) as further described below.

As shown, the 5G mobile network environment can also include 5G Radio Access Network (RAN) access (e.g., gNodeB (gNB)) as shown at 104B, and/or other networks (not shown in FIG. 1B) to facilitate data communications for subscribers (e.g., using User Equipment (UE), such as smart phones, laptops, computers (which may be in a fixed location), and/or other cellular enabled computing devices/equipment, such as IoT devices as shown at 102, or other network communication enabled devices, such as Industrial IoT (IIoT), etc.) including over a Packet Data Network (PDN) (e.g., the Internet) 120 to access various applications (e.g., including Software Applications as a Services (SaaS)), web services, content hosts, etc. and/or other networks. As shown in FIG. 1B, the 5G network access mechanisms 104B are in communication (e.g., via an N3 interface) with 5G Mobile Core User Plane (UP) Function (UPF) 132 and are in communication over various interfaces, including the N2 interface and the N3 interface with 5G Core network 106b.

In this example implementation, security platform (e.g., NGFW) 110 is located in 5G Core network 106b between 5G RAN 104b and User Plane Function (UPF) 132 via the N3 interface as shown and also between 5G RAN 104b and Session Management Function (SMF) 134 via the N2 interface, as also shown in FIG. 1B. UPF 132 is also in communication with PDN (e.g., Internet) 120 via the N6 interface.

Referring to FIG. 1B, network traffic communications are monitored using Security Platform 110. As shown, network traffic communications are monitored/filtered in the 5G network using Security Platform 110 (e.g., (virtual) devices/appliances that each include a firewall (FW), a network sensor acting on behalf of the firewall, or another device/component that can implement security policies using the disclosed techniques) configured to perform the disclosed techniques for applying context-based security by inspecting interfaces, such as in this example 5G network environment, N2 and N3 interfaces, such as similarly described above and as further described below.

In some embodiments, the security platform is configured to provide the following DPI capabilities: inspection of Next Generation Application Protocol (NGAP) traffic over N2 interface and GPRS Tunneling Protocol User Plane (GTP-U) over N3 interface and to apply context-based security as described herein.

As such, in this example implementation for a private 5G mobile network deployment, a security platform (e.g., NGFW and/or another security platform/device/entity/function) is deployed in a private 5G network. Specifically, the security platform is configured to monitor predetermined interfaces in the private 5G network, including in this example implementation, N2 and N3 interfaces.

Specifically, various techniques are disclosed to provide context-based visibility and security enforcement capabilities by inspecting the N2 and N3 interfaces in a 5G Core network as will now be further described below.

In an example implementation, a security platform is deployed in a 5G Core network, such as shown in FIG. 1B, and the security platform is configured to monitor the N2 and N3 interfaces. Specifically, the security platform is configured to perform DPI and processing of NGAP messages including “Initial Context Setup Request” exchanged between a 5G RAN node (104b) and a UPF (132) during an “Initial Context Setup Procedure” (e.g., as specified in 3GPP Technical Specification (TS) 38.413 version 18.4.0, which is publicly available at https://www.etsi.org/deliver/etsi_TS/138400_138499/138413/18.04.00_60/ts_138413v180400p.pdf) to extract the following example parameters/information: UE Internet Protocol (IP) address, General Packet Radio Service (GPRS) Tunneling Protocol (GTP) Tunnel Endpoint Identifier (GTP-TEID), and International Mobile Equipment Identifier (IMEI)/Permanent Equipment Identifier (PEI).

In addition, the NGAP “Initial Context Setup request” message includes masked International Mobile Equipment Identity-Software Version (IMEISV) by default. The Access Management Function (AMF) (not shown in FIG. 1B, see, for example, AMF 162 as shown in FIG. 1D) of certain 5G mobile core equipment vendors have a configuration option to enable and disable the masking of the IMEISV. In a public network, masking the IMEI is generally a default for security purposes. However, in private 5G networks, the IMEISV masking can be disabled to facilitate collecting of equipment identity for adding advanced network level security for UEs. As such, in private 5G network deployments in which the IMEISV masking is disabled, then the security platform can also be configured to extract the IMEI information.

Technical details for monitoring predetermined interfaces including, for example, N2 and N3 interfaces in private 5G networks using a security platform will be further described below with respect to various embodiments.

Moreover, the security platform can correlate the context information with the user plane traffic to deliver enhanced context-based security capabilities for network traffic in 5G networks.

In addition, Security Platform 110 can also be in network communication with a Cloud Security Service 122 (e.g., a commercially available cloud-based security service, such as the WildFire^{TM} cloud-based malware analysis environment that is a commercially available cloud security service provided by Palo Alto Networks, Inc., which includes automated security analysis of malware samples as well as security expert analysis, or a similar solution provided by another vendor can be utilized), such as via the Internet. For example, Cloud Security Service 122 can be utilized to provide the Security Platforms with dynamic prevention signatures for malware, DNS, URLs, CNC malware, and/or other malware as well as to receive malware samples for further security analysis.

As will now be apparent to one of ordinary skill in the art in view of the disclosed embodiments, various other security platform deployments in private 5G networks can similarly be used to facilitate providing context-based security by inspecting interfaces in a 5G network as described herein. For example, as will now be apparent, network traffic communications can be monitored/filtered at the interfaces (e.g., N2, N3, N6, etc.) in private 5G networks using one or more security platforms for network traffic communications in various locations within the private 5G network (e.g., private enterprise 5G network) to facilitate applying context-based security by inspecting interfaces in mobile networks.

FIG. 1C is an example deployment architecture diagram for providing context-based security by inspecting interfaces in an Open RAN 5G network in accordance with some embodiments. In this example deployment, a security platform (e.g., NGFW) as shown at 110 is deployed in a location within Open RAN 5G core mobile network 106c to monitor N2 and N3 interfaces to facilitate providing context-based security by inspecting interfaces in a 5G network (e.g., a private/enterprise 5G network) as further described below.

In this example deployment, a security platform (e.g., NGFW) as shown at 110 is deployed to monitor N2 and N3 interfaces to facilitate providing context-based security by inspecting interfaces in an Open RAN (O-RAN) 5G network (e.g., a private/enterprise 5G network in an O-RAN environment) as further described below.

Specifically, FIG. 1C is an example 5G mobile network environment that includes a Security Platform 110 (e.g., the security function(s)/platform(s) can be implemented using a firewall (FW)/Next Generation Firewall (NGFW), a network sensor acting on behalf of the firewall, or another (virtual) device/component that can implement security policies using the disclosed techniques, including, for example, Palo Alto Networks' PA Series next generation firewalls, Palo Alto Networks' VM Series virtualized next generation firewalls, and CN Series container next generation firewalls, and/or other commercially available virtual-based or container-based firewalls can similarly be implemented and configured to perform the disclosed techniques) for applying context-based security by inspecting interfaces in O-RAN environments in mobile networks (e.g., 4G, 5G, 6G, or later generation mobile networks) as further described below.

As shown in FIG. 1C, the 5G network access mechanism, 5G RAN 104b, is in communication with an O-RAN Distributed Unit (O-DU) 142 to facilitate network communications for UE (e.g., UE and IoT as shown at 102). O-DU 142 is in communication (e.g., via an F1-C interface) with O-RAN Centralized Unit User Plane (O-CU-UP) 144 and is also in communication (e.g., via an F1-U interface) with O-RAN Centralized Unit Control Plane (O-CU-CP) 146. O-CU-UP 144 is in communication (e.g., via an N3 interface) with 5G Mobile Core User Plane (UP) Function 132, which is in communication with PDN (e.g., Internet) 120. O-CU-CP 146 is in communication (e.g., via an N2 interface as shown in FIG. 1C) with 5G Mobile Core Control Plane (CP) Function (not shown in FIG. 1C).

Referring to FIG. 1C, network traffic communications are monitored using Security Platform 110. As shown, network traffic communications are monitored/filtered in the 5G network using Security Platform 110 (e.g., (virtual) devices/appliances that each include a firewall (FW), a network sensor acting on behalf of the firewall, or another device/component that can implement security policies using the disclosed techniques, including, for example, Palo Alto Networks' PA Series next generation firewalls, Palo Alto Networks' VM Series virtualized next generation firewalls, and CN Series container next generation firewalls, and/or other commercially available virtual-based or container-based firewalls can similarly be implemented and configured to perform the disclosed techniques) configured to perform the disclosed techniques for applying context-based security over interfaces in an O-RAN environment in mobile networks as similarly described above and as further described below.

Specifically, various techniques are disclosed to provide context-based visibility and security enforcement capabilities by inspecting the N2 and N3 interfaces in a 5G O-RAN environment as similarly described above with respect to FIG. 1B and as will also be further described below.

In an example implementation, a security platform is deployed in a 5G O-RAN environment, such as shown in FIG. 1C, and the security platform is configured to monitor the N2 and N3 interfaces. Specifically, the security platform is configured to perform DPI and processing of NGAP messages including “Initial Context Setup Request” exchanged between a 5G RAN node (104b) and a UPF (132) during an “Initial Context Setup Procedure” (e.g., as specified in 3GPP Technical Specification (TS) 38.413 version 18.4.0, which is publicly available at https://www.etsi.org/deliver/etsi_TS/138400_138499/138413/18.04.00_60/ts_138413v180400p.pdf) to extract the following example parameters/information: UE Internet Protocol (IP) address, General Packet Radio Service (GPRS) Tunneling Protocol (GTP) Tunnel Endpoint Identifier (GTP-TEID), and International Mobile Equipment Identifier (IMEI)/Permanent Equipment Identifier (PEI).

In addition, the NGAP “Initial Context Setup request” message includes masked International Mobile Equipment Identity-Software Version (IMEISV) by default. The Access Management Function (AMF) (not shown in FIG. 1C, see, for example, AMF 162 as shown in FIG. 1D) of certain 5G mobile core equipment vendors have a configuration option to enable and disable the masking of the IMEISV. In a public network, masking the IMEI is generally a default for security purposes. However, in private 5G networks, the IMEISV masking can be disabled to facilitate collecting of equipment identity for adding advanced network level security for UEs. As such, in private 5G network deployments in which the IMEISV masking is disabled, then the security platform can also be configured to extract the IMEI information.

Technical details for monitoring predetermined interfaces including, for example, N2 and N3 interfaces in private 5G networks using a security platform will be further described below with respect to various embodiments.

Moreover, the security platform can correlate the context information with the user plane traffic to deliver enhanced context-based security capabilities for network traffic in O-RAN environments.

In addition, Security Platform 110 can also be in network communication with a Cloud Security Service 122 (e.g., a commercially available cloud-based security service, such as the WildFire™ cloud-based malware analysis environment that is a commercially available cloud security service provided by Palo Alto Networks, Inc., which includes automated security analysis of malware samples as well as security expert analysis, or a similar solution provided by another vendor can be utilized), such as via the Internet. For example, Cloud Security Service 122 can be utilized to provide the Security Platforms with dynamic prevention signatures for malware, DNS, URLs, CNC malware, and/or other malware as well as to receive malware samples for further security analysis.

As will now be apparent to one of ordinary skill in the art in view of the disclosed embodiments, various other security platform deployments in private 5G O-RAN network environments can similarly be used to facilitate providing context-based security by inspecting interfaces in a 5G O-RAN network as described herein. For example, as will now be apparent, network traffic communications can be monitored/filtered at the interfaces (e.g., N2, N3, N6, etc.) in private 5G O-RAN networks using one or more security platforms for network traffic communications in various locations within the private 5G O-RAN network (e.g., private enterprise 5G O-RAN network) to facilitate applying context-based security by inspecting interfaces in mobile networks.

FIG. 1D is an example deployment architecture diagram for providing context-based security by inspecting interfaces in a 4G access, 5G access, and 4G-5G mobility network environment in accordance with some embodiments. In this example deployment, a security platform (e.g., NGFW) as shown at 110 is deployed in a location within 4G access, 5G access, and 4G-5G mobility network environment 106d to monitor N2, N3, S1-MME, and S1-U interfaces to facilitate providing context-based security by inspecting interfaces in a 4G access, 5G access, and 4G-5G mobility network environment (e.g., a private/enterprise 4G and 5G network) as further described below.

Specifically, FIG. 1D is an example 4G and 5G mobile network environment that includes a Security Platform 110 (e.g., the security function(s)/platform(s) can be implemented using a firewall (FW)/Next Generation Firewall (NGFW), a network sensor acting on behalf of the firewall, or another (virtual) device/component that can implement security policies using the disclosed techniques, including, for example, Palo Alto Networks' PA Series next generation firewalls, Palo Alto Networks' VM Series virtualized next generation firewalls, and CN Series container next generation firewalls, and/or other commercially available virtual-based or container-based firewalls can similarly be implemented and configured to perform the disclosed techniques) for applying context-based security by inspecting interfaces in mobile networks (e.g., 4G, 5G, 6G, or later generation mobile networks) as further described below.

As shown, the 5G mobile network environment can also include 5G Radio Access Network (RAN) access (e.g., gNB) as shown at 104b and Evolved Universal Terrestrial Radio Access Network (EUTRAN) (e.g., for Long Term Evolution (LTE) mobile/radio communications) as shown at 104c, and/or other networks (not shown in FIG. 1D) to facilitate data communications for subscribers using UE & IoT as shown at 102 (e.g., such as smart phones, laptops, computers (which may be in a fixed location), and/or other cellular enabled computing devices/equipment, or other network communication enabled devices, such as IIoT, etc.) including over PDN (e.g., the Internet) 120 to access various applications, web services, content hosts, etc. and/or other networks. As shown in FIG. 1D, each of the 4G and 5G network access mechanisms (e.g., as shown at 104b and 104c respectively) are in communication (e.g., via N2 and N3 interfaces, and via S1-U and S1-MME interfaces, respectively) with 5G Core and Evolved Packet Core (EPC)/4G Core network environment 106d.

Referring to the 5G data path, for example, 5G RAN 104b and Mobile Core User Plane (UP) Function and PDN Gateway User Plane Function (PGW-U) 164 are in communication (e.g., via an N3 interface), which is in communication with PDN (e.g., the Internet) 120 (e.g., via the N6 interface). Also, 5G RAN 104b and Access and Mobility Management Function (AMF) 162 are in communication (e.g., via an N2 interface).

Referring to the 4G/LTE data path, for example, EUTRAN 104c and SGW 114 are in communication (e.g., via an S1-U interface). Also, EUTRAN 104c and MME 112 are in communication (e.g., via an S1-MME interface).

Referring to FIG. 1D, network traffic communications are monitored using Security Platform 110. As shown, network traffic communications are monitored/filtered in the 5G Core and EPC/4G Core network using Security Platform 110 (e.g., (virtual) devices/appliances that each include a firewall (FW), a network sensor acting on behalf of the firewall, or another device/component that can implement security policies using the disclosed techniques) configured to perform the disclosed techniques for applying context-based security over interfaces in the 5G Core and EPC/4G Core network environment as similarly described above and as further described below.

Specifically, various techniques are disclosed to provide context-based visibility and security enforcement capabilities by inspecting the S1-U and S1-MME interfaces in the 4G/LTE network environment as similarly described above with respect to FIG. 1A and also by inspecting the N2, N3 interfaces in the 5G network environment as similarly described above with respect to FIG. 1B and as will also be further described below with respect to various embodiments.

In addition, Security Platform 110 can also be in network communication with a Cloud Security Service 122 (e.g., a commercially available cloud-based security service, such as the WildFire™ cloud-based malware analysis environment that is a commercially available cloud security service provided by Palo Alto Networks, Inc., which includes automated security analysis of malware samples as well as security expert analysis, or a similar solution provided by another vendor can be utilized), such as via the Internet. For example, Cloud Security Service 122 can be utilized to provide the Security Platforms with dynamic prevention signatures for malware, DNS, URLs, CNC malware, and/or other malware as well as to receive malware samples for further security analysis.

As will now be apparent to one of ordinary skill in the art in view of the disclosed embodiments, various other security platform deployments in private 4G and private 5G networks can similarly be used to facilitate providing context-based security by inspecting interfaces in private 4G and private 5G networks as described herein. For example, as will now be apparent, network traffic communications can be monitored/filtered at the interfaces in private 4G and private 5G networks using one or more security platforms for network traffic communications in various locations within the private 4G and private 5G networks (e.g., private enterprise 4G/5G network) to facilitate applying context-based security by inspecting interfaces in mobile networks.

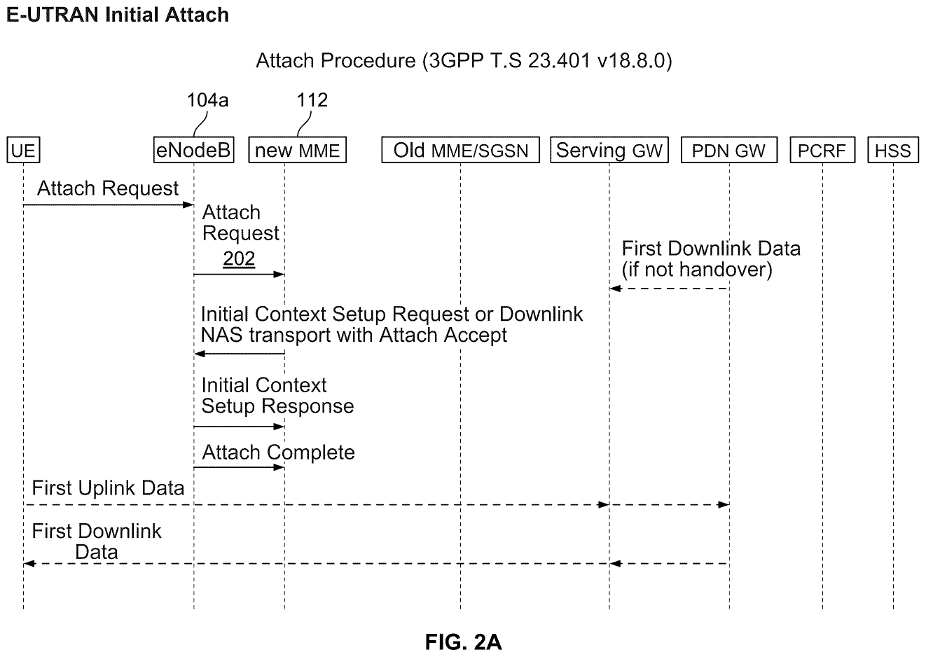

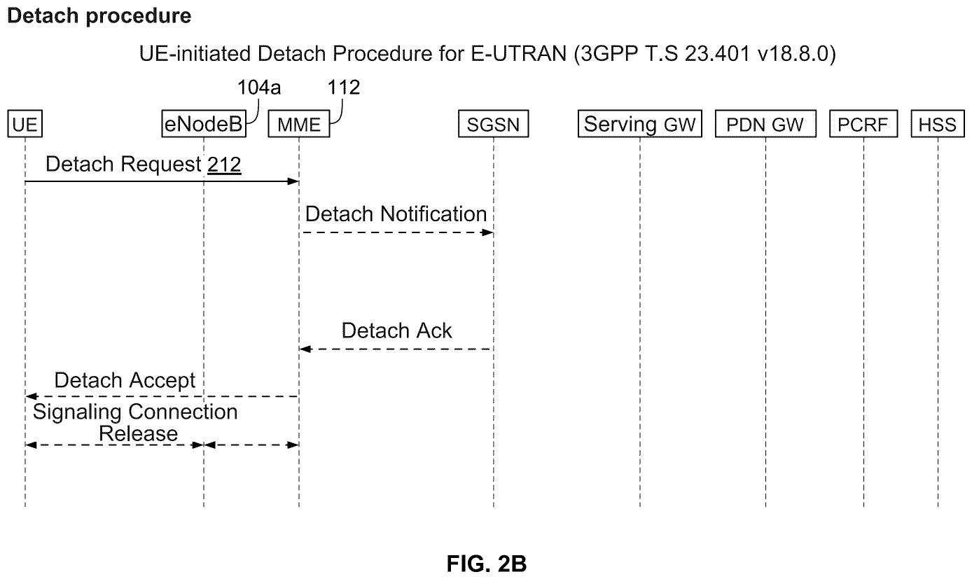

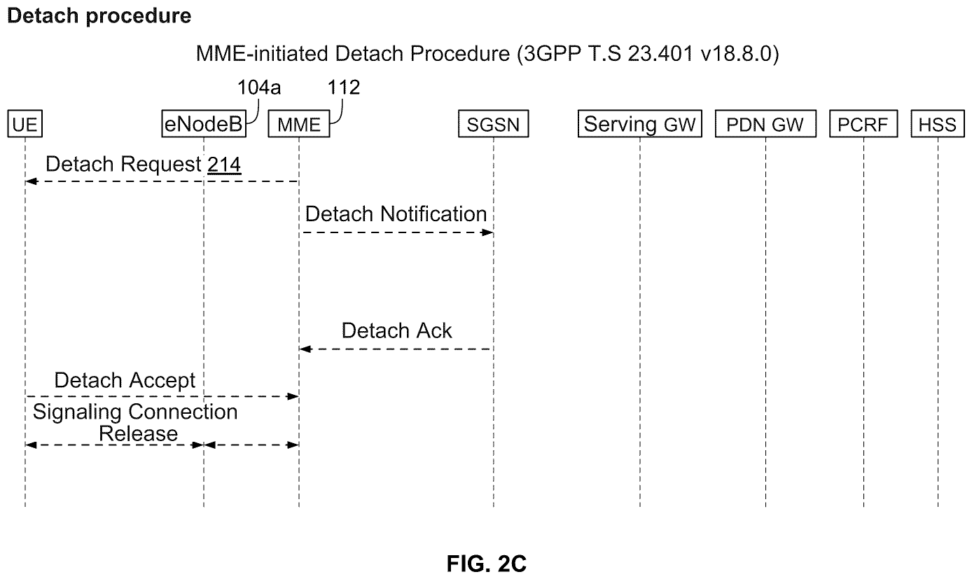

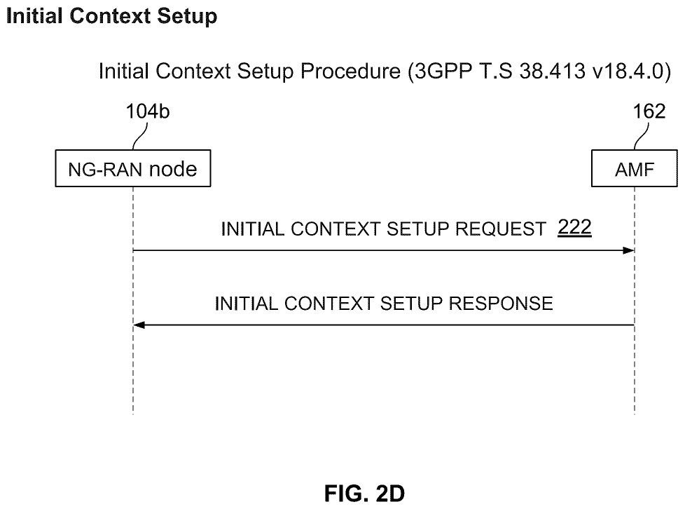

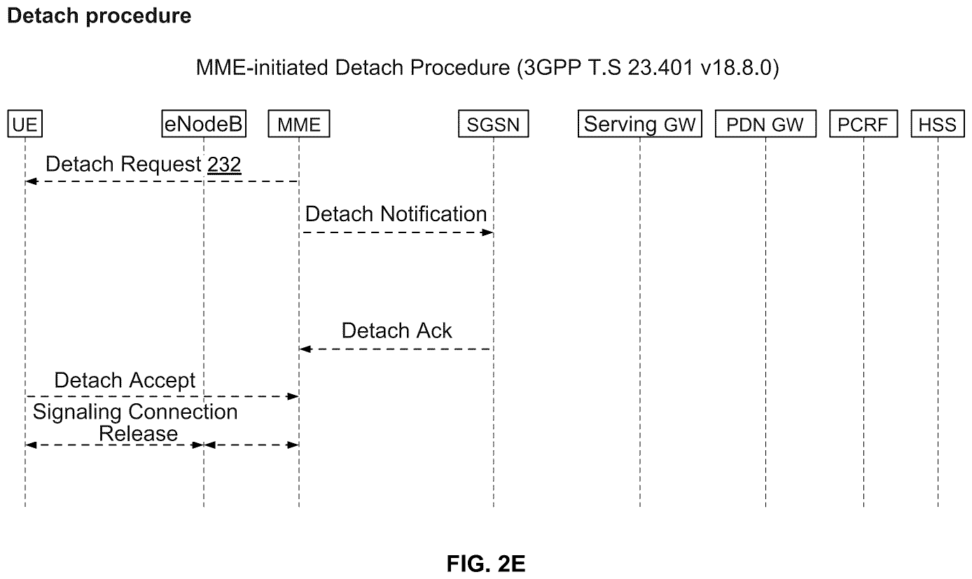

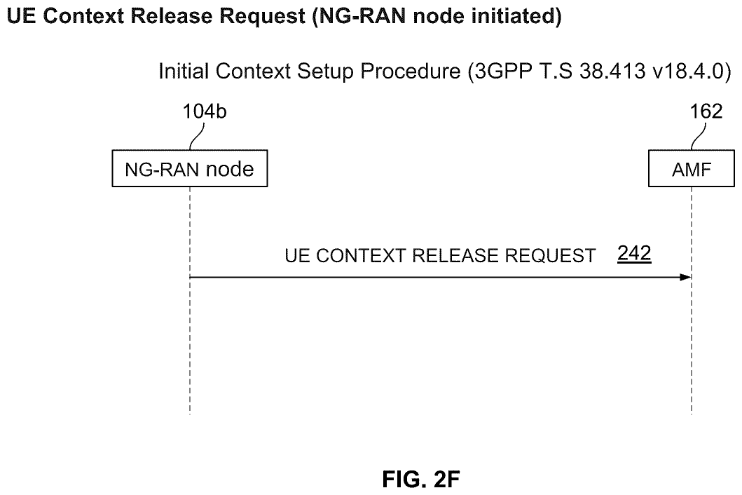

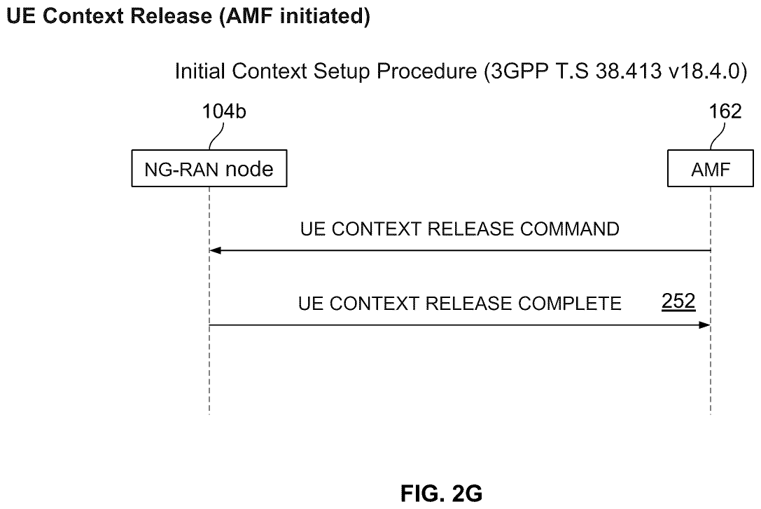

FIG. 2A is a sequence diagram for an E-UTRAN initial attach in a 4G/LTE network environment in accordance with some embodiments.

As similarly described above, example monitored S1AP messages include the “Attach Request” message 202 as shown in FIG. 2A that is exchanged between an eNB 104a (e.g., as also shown in FIG. 1A) and an MME 112 (e.g., as also shown in FIG. 1A) during an “Attach procedure” (e.g., as specified in 3GPP TS 23.401 version 18.8.0) to extract the following example parameters/information: Transport Layer Internet Protocol (IP) address, General Packet Radio Service (GPRS) Tunneling Protocol (GTP) Tunnel Endpoint Identifier (GTP-TEID), International Mobile Equipment Identifier (IMEI), Mobile Temporary Mobile Subscriber Identity (M-TMSI), Access Point Name (APN)/Data Network Name (DNN), and Location information.

FIG. 2B is a sequence diagram for a UE-initiated detach procedure for E-UTRAN in a 4G/LTE network environment in accordance with some embodiments.

FIG. 2C is a sequence diagram for an MME-initiated detach procedure for E-UTRAN in a 4G/LTE network environment in accordance with some embodiments.

In an example implementation, a security platform (e.g., such as NGFW 110 as shown in FIG. 1A) is configured to perform the following operations.

At a first stage, the security platform stores GTP-TEID, Transport Address, and contextual information including, for example, IMEI, APN, and Location information in a data store (e.g., a database, which can be stored locally in the security platform or using a cloud-based storage service/solution), such as similarly described above with respect to FIG. 1A.

At a second stage, the security platform monitors GTP-U traffic to extract GTP-TEID, Transport Address, and UE IP Address, such as similarly described above with respect to FIG. 1A.

At a third stage, the security platform uses the GTP-TEID to correlate the information collected in the first and second stages to populate UE IP mappings including, for example, UE IP address, IMEI, M-TMSI, Location, and APN in the data store.

Finally, the security platform removes entry of a UE IP and related contextual information from the data store if a “Detach Request” message (e.g., such as shown at 232 in FIG. 2E) is received at MME 112 as shown at 212 in FIG. 2B and/or as shown at 214 in FIG. 2C (e.g., as specified in 3GPP TS 23.401 version 18.8.0) to detach the UE from the network or switch off. In this example implementation, the M-TMSI parameter can be used to delete the UE IP entry.

Also, the security platform can be configured to remove entry of a UE IP and related contextual information from the data store if User/Subscriber sessions timeout. In this example implementation, the timeout is a configurable setting.

FIG. 2D is a sequence diagram for an initial context setup procedure in a 5G network environment in accordance with some embodiments.

As similarly described above, example monitored NGAP messages include an “Initial Context Setup Request” message as shown at 222 in FIG. 2D, which is exchanged between a NG-RAN node (104b) and AMF 162 (e.g., as also shown at 162 in FIG. 1D) (e.g., or similarly, such as shown at UPF 132 in FIG. 1B) and/or during an “Initial Context Setup Procedure” (e.g., as specified in 3GPP TS 38.413 version 18.4.0,) to extract the following example parameters/information: Transport Layer IP Address, PDU Session ID, General Packet Radio Service (GPRS) Tunneling Protocol (GTP) Tunnel Endpoint Identifier (GTP-TEID), and International Mobile Equipment Identifier (IMEI)/Permanent Equipment Identifier (PEI).

FIG. 2E is a sequence diagram for a UE-initiated detach procedure in a 5G network environment in accordance with some embodiments.

FIG. 2F is a sequence diagram for a UE context release procedure (NG-RAN node initiated) in a 5G network environment in accordance with some embodiments.

FIG. 2G is a sequence diagram for a UE context release procedure (AMF initiated) in a 5G network environment in accordance with some embodiments.

In an example implementation, a security platform (e.g., such as NGFW 110 as shown in FIG. 1B) is configured to perform the following operations.

At a first stage, the security platform extracts the GTP-TEID and Transport address from “UL NG-U UP TNL Information” IE (e.g., UP Transport Layer Information) in “PDU Session Resource Setup Request Transfer” IE in “Initial Context Setup Request” NGAP message (e.g., as shown at 222 in FIG. 2D). The security platform can also extract the “PDU Session ID” from the “Initial Context Setup Request” NGAP message. The security platform can store the GTP-TEID, Transport Address, PDU Session ID, and contextual information including, for example, the IMEI in a data store (e.g., a database, which can be stored locally in the security platform or using a cloud-based storage service/solution).

At a second stage, the security platform monitors GTP-U traffic to extract GTP-TEID, Transport Address, and UE IP Address, such as similarly described above with respect to FIG. 1B.

At a third stage, the security platform uses the GTP-TEID to correlate the information collected in the first and second stages to populate UE IP mappings including, for example, UE IP address and IMEI in the data store.

Finally, the security platform removes entry of a UE IP and related contextual information from the database if a “UE Context Release” message is received during one of the context release procedures as specified in 3GPP T.S 38.413 v18.4.0 to release the UE-associated logical NG-connection from the network, such as shown in FIG. 2F (e.g., as shown at 242) and 2G (e.g., as shown at 252). In this example implementation, the “PDU Session ID” can be used to delete the UE IP entry.

Also, as similarly described above, the security platform can be configured to remove entry of a UE IP and related contextual information from the data store if User/Subscriber sessions timeout. In this example implementation, the timeout is a configurable setting.

Various example use cases for providing context-based security by inspecting interfaces in mobile networks will be described below.

### Example Use Cases for Providing Context-Based Security by Inspecting Interfaces Between RAN and Core in Mobile Networks

Various example use cases for providing context-based security by inspecting interfaces in mobile networks will now be described below.

As a first example use case, the disclosed techniques for providing context-based security by inspecting interfaces in mobile networks can be applied to provide user and/or device identity based security in an enterprise 4G/LTE network and/or enterprise 5G network.

As a second example use case, the disclosed techniques for providing context-based security by inspecting interfaces in mobile networks can be applied to provide advanced Layer 7 (L7) security control for devices (e.g., critical infrastructure devices) connected to a 4G/LTE network and/or 5G network.

As a third example use case, the disclosed techniques for providing context-based security by inspecting interfaces in mobile networks can be applied to facilitate a Service Provider offering advanced threat prevention service to its customers (e.g., manufacturing vertical enterprise 4G/LTE customer and/or manufacturing vertical enterprise 5G customer).

As a fourth example use case, the disclosed techniques for providing context-based security by inspecting interfaces in mobile networks can be applied to provide context-based security, including based on Equipment-ID, Location, and APN, in private mobile networks and/or service provider mobile networks without dependence on network equipment vendors providing open interfaces.

As a fifth example use case, the disclosed techniques for providing context-based security by inspecting interfaces in mobile networks can be applied to provide context-based security, including based on Equipment-ID, Location, and APN, with multiple deployment options/locations in private mobile networks and/or service provider mobile networks, such as similarly described above.

As a sixth example use case, the disclosed techniques for providing context-based security by inspecting interfaces in mobile networks can be applied to provide context-based security (e.g., including based on Equipment-ID, Location, and APN) based at least in part on application (App) identification (ID) (App ID) with multiple deployment options/locations in private mobile networks and/or service provider mobile networks, such as similarly described above.

As a seventh example use case, the disclosed techniques for providing context-based security by inspecting interfaces in mobile networks can be applied to provide context-based security (e.g., including based on Equipment-ID, Location, and APN) for known and unknown threat identification and prevention with multiple deployment options/locations in private mobile networks and/or service provider mobile networks, such as similarly described above.

As an eighth example use case, the disclosed techniques for providing context-based security by inspecting interfaces in mobile networks can be applied to provide context-based security (e.g., including based on Equipment-ID, Location, and APN) for Uniform Resource Link (URL) filtering with multiple deployment options/locations in private mobile networks and/or service provider mobile networks, such as similarly described above.

Additional example process embodiments for providing context-based security by inspecting interfaces in mobile networks will be further described below.

### Example Process Embodiments for Providing Context-Based Security by Inspecting Interfaces Between RAN and Core in Mobile Networks

Various process embodiments for providing a security policy per UE behavior in mobile networks will now be further described below.

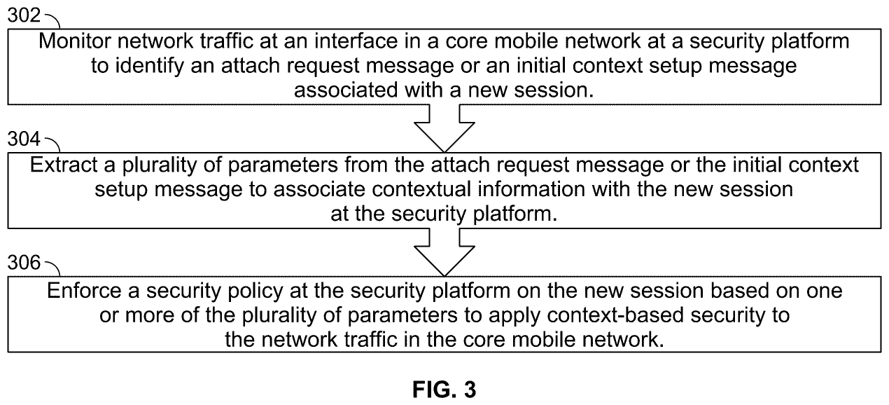

FIG. 3 is a flow diagram of a process for providing context-based security by inspecting interfaces in mobile networks in accordance with some embodiments. In some embodiments, a process as shown in FIG. 3 is performed by the security platform and techniques as similarly described above including the embodiments described above with respect to FIGS. 1A-2G. In one embodiment, the process is performed as described above with respect to FIGS. 1A-1D by a security platform 110 (e.g., Palo Alto Networks' VM Series virtualized next generation firewalls, CN Series container next generation firewalls, and/or other commercially available virtual-based or container-based firewalls can similarly be implemented and configured to perform the disclosed techniques), an SDN security solution, a cloud security service, and/or combinations or hybrid implementations of the aforementioned as described herein.

At 302, monitoring network traffic at an interface in a core mobile network is performed at a security platform to identify an attach request message or an initial context setup message associated with a new session.

At 304, a plurality of parameters is extracted from the attach request message or the initial context setup message to associate contextual information with the new session at the security platform.

At 306, enforcing a security policy is performed at the security platform on the new session based on one or more of the plurality of parameters to apply context-based security to the network traffic in the core mobile network.

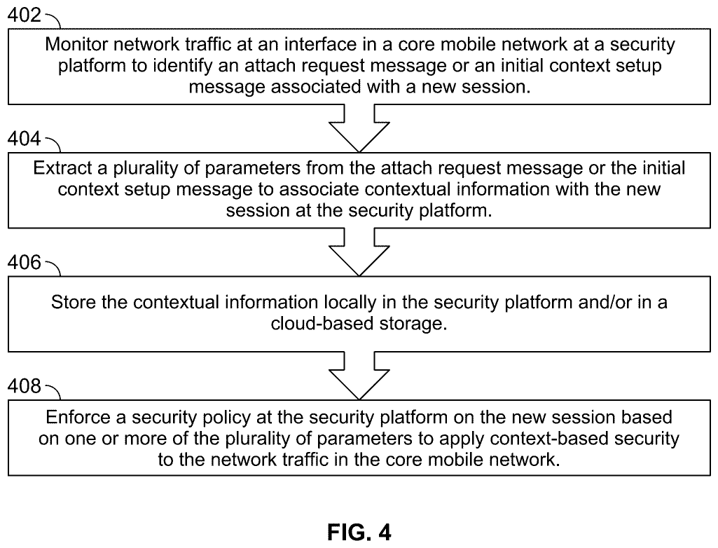

FIG. 4 is another flow diagram of a process for providing context-based security by inspecting interfaces in mobile networks in accordance with some embodiments. In some embodiments, a process as shown in FIG. 3 is performed by the security platform and techniques as similarly described above including the embodiments described above with respect to FIGS. 1A-2G. In one embodiment, the process is performed as described above with respect to FIGS. 1A-1D by a security platform 110 (e.g., Palo Alto Networks' VM Series virtualized next generation firewalls, CN Series container next generation firewalls, and/or other commercially available virtual-based or container-based firewalls can similarly be implemented and configured to perform the disclosed techniques), an SDN security solution, a cloud security service, and/or combinations or hybrid implementations of the aforementioned as described herein.

At 402, monitoring network traffic at an interface in a core mobile network is performed at a security platform to identify an attach request message or an initial context setup message associated with a new session.

At 404, a plurality of parameters is extracted from the attach request message or the initial context setup message to associate contextual information with the new session at the security platform.

At 406, the contextual information is stored locally in the security platform and/or in a cloud-based storage.

At 408, enforcing a security policy is performed at the security platform on the new session based on one or more of the plurality of parameters to apply context-based security to the network traffic in the core mobile network.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a processor configured to:
monitor network traffic at an interface between a radio access network (RAN) and a core of a mobile network at a security platform to identify an attach request message or an initial context setup message associated with a new session;
extract a plurality of parameters from the attach request message or the initial context setup message to associate contextual information with the new session at the security platform; and
enforce a security policy at the security platform on the new session based on one or more of the plurality of parameters to apply context-based security to the network traffic in the mobile network; and
a memory coupled to the processor and configured to provide the processor with instructions.

2. The system recited in claim 1, wherein the mobile network includes a 4G/Long Term Evolution (LTE) network.

3. The system recited in claim 1, wherein the mobile network includes a 5G network.

4. The system recited in claim 1, wherein the mobile network includes an Open Radio Access Network (RAN) network.

5. The system recited in claim 1, wherein the mobile network includes a 4G/Long Term Evolution (LTE) core and a 5G core.

6. The system recited in claim 1, wherein the processor is further configured to:
monitor the network traffic at an S1-MME interface and an S1-U interface in a 4G/Long Term Evolution (LTE) network at the security platform to identify the attach request message associated with the new session.

7. The system recited in claim 1, wherein the processor is further configured to:
monitor the network traffic at an S1-MME interface and/or an S1-U interface in a 4G/Long Term Evolution (LTE) network at the security platform to identify the attach request message associated with the new session to extract the contextual information; and
store the contextual information locally in the security platform or in a cloud-based storage.

8. The system recited in claim 1, wherein the processor is further configured to:
monitor the network traffic at an N2 interface and/or an N3 interface in a 5G network and/or an Open Radio Access Network (Open RAN) network at the security platform to identify the initial context setup message associated with the new session.

9. The system recited in claim 1, wherein the processor is further configured to:
monitor the network traffic at an N2 interface and/or an N3 interface in a 5G network and/or an Open Radio Access Network (Open RAN) network at the security platform to identify the initial context setup message associated with the new session; and
store the contextual information locally in the security platform or in a cloud-based storage.

10. The system recited in claim 1, wherein the extracted plurality of parameters includes one or more of the following: Transport Layer Internet Protocol (IP) address, General Packet Radio Service (GPRS) Tunneling Protocol (GTP) Tunnel Endpoint Identifier (GTP-TEID), International Mobile Equipment Identifier (IMEI), Mobile Temporary Mobile Subscriber Identity (M-TMSI), Access Point Name (APN)/Data Network Name (DNN), and Location information.

11. The system recited in claim 1, wherein the extracted plurality of parameters includes one or more of the following: UE Internet Protocol (IP) address, General Packet Radio Service (GPRS) Tunneling Protocol (GTP) Tunnel Endpoint Identifier (GTP-TEID), and International Mobile Equipment Identifier (IMEI)/Permanent Equipment Identifier (PEI).

12. The system recited in claim 1, wherein the mobile network includes a private mobile network, and wherein the extracted plurality of parameters includes masked International Mobile Equipment Identity-Software Version (IMEISV).

13. The system recited in claim 1, wherein the security platform is configured to perform detection and prevention of known and unknown threat identification and prevention in a private mobile network and/or a service provider network.

14. The system recited in claim 1, wherein the security platform is configured to perform application identification and control in a private mobile network and/or a service provider network.

15. The system recited in claim 1, wherein the security platform is configured to perform Uniform Resource Link (URL) filtering in a private mobile network and/or a service provider network.

16. The system recited in claim 1, wherein the processor is further configured to:
block the new session from accessing a resource based on the security policy.

17. The system recited in claim 1, wherein the processor is further configured to:
allow the new session to access a resource based on the security policy.

18. A method, comprising:
monitoring network traffic at an interface between a radio access network (RAN) and a core of a mobile network at a security platform to identify an attach request message or an initial context setup message associated with a new session;
extracting a plurality of parameters from the attach request message or the initial context setup message to associate contextual information with the new session at the security platform; and
enforcing a security policy at the security platform on the new session based on one or more of the plurality of parameters to apply context-based security to the network traffic in the mobile network.

19. The method of claim 18, wherein the mobile network includes a 4G/Long Term Evolution (LTE) network, a 5G network, and/or an Open Radio Access Network (RAN) network.

20. A computer program product, the computer program product being embodied in a non-transitory computer readable storage medium and comprising computer instructions for:
monitoring network traffic at an interface between a radio access network (RAN) and a core of a mobile network at a security platform to identify an attach request message or an initial context setup message associated with a new session;
extracting a plurality of parameters from the attach request message or the initial context setup message to associate contextual information with the new session at the security platform; and
enforcing a security policy at the security platform on the new session based on one or more of the plurality of parameters to apply context-based security to the network traffic in the mobile network.
